(19) United States
(12) Patent Application Publication
(10) Pub. No.: US 2013/0254261 A1
(43) Pub. Date: Sep. 26, 2013

(54) System and Method of Managing Servers for Streaming Desktop Applications

(71) Applicant: Jason Frederick Nicholls, (US)

(72) Inventor: Jason Frederick Nicholls, (US)

(21) Appl. No.: 13/533,898

(22) Filed: Jun. 26, 2012

Related U.S. Application Data
(60) Provisional application No. 61/685,736, filed on Mar. 21, 2012.

(51) Int. Cl. G06F 15/16

(52) U.S. Cl. 709/203

(57) ABSTRACT

A method of a client device accessing server based applications comprising the steps of communicating to a management server an application identifier and a client identifier to the management server over a global network. Then determining a set of available worker servers from a plurality of worker servers by the management server and selecting a worker server. A desktop operating system is loaded on one the worker server along with application-persistent data associated with the client identifier and associated with the application identifier from a database. The application is then executes the application on the worker server and stores in the database current application-persistent data associated with the client identifier.

### CROSS REFERENCE TO OTHER APPLICATIONS

This application claims priority to application entitled “SYSTEM METHOD DEVICE FOR STREAMING VIDEO” Ser. No. 13/471,546 filed May 15 which claims priority under 35 U.S.C. §119(e) of the co-pending U.S. provisional patent application Ser. No. 61/685,736 filed on Mar. 21, 2012, and titled “DEVICE SYSTEM METHOD FOR STREAMING VIDEO.” The application “SYSTEM METHOD DEVICE FOR STREAMING VIDEO” Ser. No. 13/471,546 filed May 15 and U.S. provisional patent application Ser. No. 61/685,736 filed on Mar. 21, 2012, and titled “DEVICE SYSTEM METHOD FOR STREAMING VIDEO” are incorporated by reference in their entirety.

### FIELD OF THE INVENTION

This invention relates generally to systems and methods of selecting and allocating servers to execute desktop application and stream the application generated multi-media content to a client device and manage application-persistence data between executions of different servers.

### BACKGROUND

A server can be configured with an operating execution environment where a computer desktop application normally operating on a single integrated computer can execute in a client server system model. However, this client server architecture causes several issues. First, one reason to use a server for executing the applications is for the server to operate as a shared resource and as a resource that is available from a pool of servers. The issue of sharing, managing, and allocating the servers needs to be addressed.

Secondly, some applications utilize application-persistent data. A gaming application stores locally state information about where the user is in the game. When the server is used as a shared resource, the application will save application-persistent data locally. After pausing the application or ending the application, the server is free as a resource for other users. However, the returning user may expect to be able to resume the application from where it was ended. The new allocated server, to which the client computer is now connected needs this prior application-persistent data to resume execution at the point where the application had left off.

Other issues include managing a pool of servers for a number of users and applications. Some applications, such as games have different computer resource requirements. Some games require or perform better with higher performance graphics cards while other applications operate well with a slower CPU (central processing unit), less memory requirement and lower performance graphics card. Thus, not all of the servers require all the same performance requirements. However, server centers typically have uniformity between the servers which can be a waste of processing resources and consume extra power. Allocations of servers are not based on a server's computational resources.

Another issue is the servers can be distributed between different data centers. The transmission delay between a server and client computer can vary between each data center.

What is needed is a system that application persistence data is available to different servers, a server selection with minimum latency between the server and client, a server selection that meets the minimum computational resources needed for the application, and the server has the application available to run.

### BRIEF DESCRIPTION OF THE DRAWINGS

FIG. 1 is a block diagram of the architecture of a system for selecting servers and streaming multi-media outputs generated by the application executing on the server.

FIG. 2 is a block diagram of a method for selecting a server and streaming multi-media to a client device.

FIG. 3 is a diagram of one embodiment of a data structure for holding worker server information.

FIG. 4 is a diagram of one embodiment of a data structure for client device information.

FIG. 5 is a diagram of one embodiment of minimum application resource requirements.

### SUMMARY OF THE INVENTION

In one aspect of the invention a system that assigns servers and streams real-time multi-media content to a client device generated by a desk top application executing on a worker server is provided. The system consists of a worker server selected from a plurality of work servers, a management server, a client device, and a database. The management server, the worker servers, and the client device can communicate over a global network.

A management server selects the worker server from the plurality of worker servers. The selection can be based on transmission latency between the client device and the worker server the computational resources required by an application to be executed in a server and if the worker server is occupied running another application. The geographic distance between the client and server can function as an estimate of the transmission latency between the worker server and client device. Further the management server is configured to communicate through the global network and can receive a client identifier and application identifier sent by the client.

Each worker server is running a desktop compatible operating system and is coupled to a global network. The operating system can be configured to take the multi-media content, including the display video, graphics, and audio, generated by the desk top application, and transmit the multi-media content to the client device over the global network. Further, the worker server is configured to receive user inputs from client device and input these user inputs into the desktop application in a manner that appears like a user is working directly on a desktop computer system. Further details of the methods and devices for streaming the real-time application generated multimedia and user inputs can be found in the incorporated application Ser. No. 13/471,546 entitled “SYSTEM METHOD DEVICE FOR STREAMING VIDEO” filed May 15, 2012.

Additionally, the worker server stores and loads in a database application-persistent data when the application is started or ended. The applications can be compatible with the Microsoft Windows® desktop operating system and the application-persistent data can include registry variables environment variables, and data files. Thus, a user of a client device application can start and stop the application where each time the application can be executed on a different worker server but the application will resume where the user last left off and behave as if restarting on the same desktop computer system.

The system includes a database in communication with the management server and the worker servers. The communication can be over a global public, private, or cellular network, including the Internet. The database stores both client information and server information. Client information can include but is not limited to the client device geo-location data, the applications that have been executed, the application-persistent data, and what applications are allowed to execute on the client device. The worker server information can include but is not limited to geo-location of the worker server and the computational resources of the server. The worker server computational resources can include CPU (central processing unit) type, CPU clock speed, number of graphic processors, amount of graphic processing memory, and the amount of random access memory available to the CPU.

The desktop operating system can includes but is not limited to Microsoft Windows desktop operating system. This operating system includes Windows XP®, Window Vista®, Windows 7®, Windows 8®, and Windows Server. The application-persistent data can include but is not limited to Windows registry variables, and environment variables that are loaded from the database for previously run applications and are saved when an application is exited. Further the database can include data files that are loaded into the worker server data structures and made available to the client device.

In another aspect of the invention, a method of allocating worker servers and streaming the application generated multimedia output to a client device is described. A client device communicates to a management server an application identifier and a client identifier. The communications is over a global network that can include but is not limited to the Internet. The application identifier indicates an application that is to be run on a worker server and is used to select the worker server that has computational resources sufficient for the identified application. The client identifier and application identifier is used to identify if there is application-persistent data stored from a previous execution of the client requested application. Further, the client is configured to receive multimedia data generated by the application executing on the worker server.

In a further step, the management server selects a worker server and executes the application. The worker server selection can be based on one or more parameters. These parameters include but are not limited to transmission latency parameter for each worker server. The transmission latency parameter can be based on a time-tagged message sent between the client and worker server or use a distance parameter as a proxy for latency where the distance is calculated for each of the plurality of worker servers and the client device. The distance information can be determined by geo-location information provided by the client or from the database where the client and worker server geo-location information is previously configured.

The worker server selection can also include matching the computational resources of the worker server with the minimum computational requirements of the client requested application.

In another step a desktop operating system is loaded on the selected worker server and executed. The operating system is modified such that the executing application generated multimedia output including but not limited to video graphics frames and audio are streamed to the client device. The operating system is further modified such that client device user inputs are streamed to the worker server and input into the operating system in a manner that appears as from a user directly connected to the worker server.

In another step, the worker server loads application-persistent data associated with client identifier and the application identifier. The previous time the application was executed by the worker server, the application-persistent data was saved in the database or one or more files upon exiting the application.

The operating system running on the worker server includes Windows desktop operating systems including Microsoft Windows XP®, Window Vista®, Windows 7®, Windows 8®, and Windows Server. The loading and saving of application-persistent data can include Window registry data and variables.

In another step, the application is ended and the current application-persistent data is saved in the database.

### DETAILED DESCRIPTION OF THE INVENTION

The following description of the invention is provided as an enabling teaching of the invention. Those skilled in the relevant art will recognize that many changes can be made to the embodiment described, while still attaining the beneficial results of the present invention. It will also be apparent that some of the desired benefits of the present invention can be attained by selecting some of the features of the present invention without utilizing other features. Accordingly, those skilled in the art will recognize that many modifications and adaptations to the present invention are possible and can even be desirable in certain circumstances, and are a part of the present invention. Thus, the following description is provided as illustrative of the principles of the present invention and not a limitation thereof.

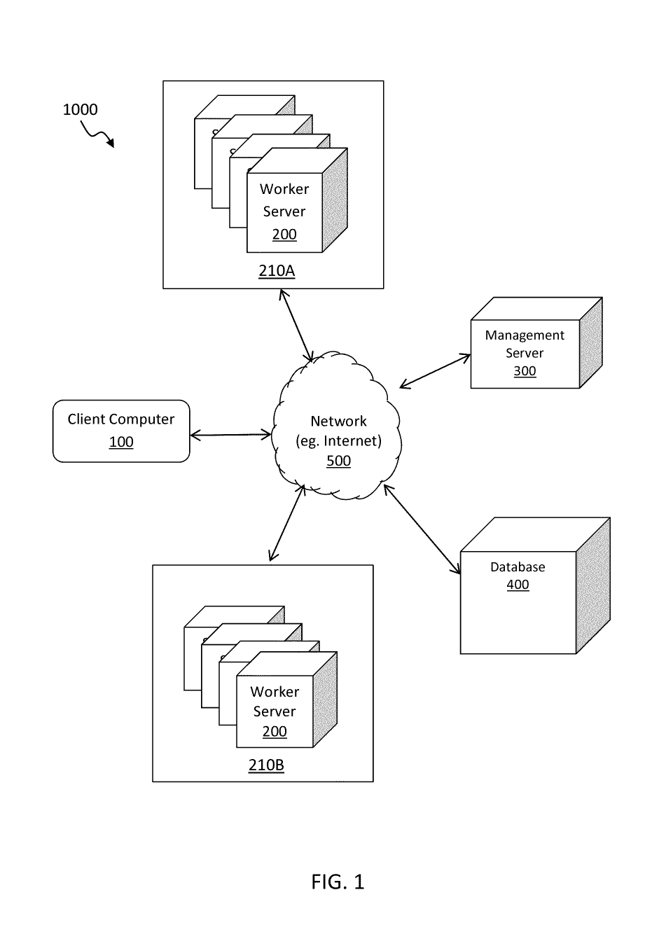

FIG. 1 is exemplar of a system 1000 for allocating worker servers 200 to executed a desk top application and stream the multimedia content generated by the application to a client device 100 over a global network 500. The system is comprised of groups of worker servers 200 that can be geographically distributed. The groups of worker servers 200 can be housed in multiple data centers 210A, 210B. The client devices 100 and worker servers 200 communicates with a management server 300 which allocates a worker server 200 to run a client requested application. A data base 400 is in communication with the worker servers 200 and the management server 300 for saving client device 100 and application associated application-persistent data, and for holding information needed to select a worker server.

The client device 100 includes computer device with one or more user interfaces. The user interfaces can include but are not limited to video and audio. The client devices include personal computers, laptops, smart phones, and tablet computer devices.

The worker server 200 can be any standard computer server that can run a desktop application. It can be a standalone device or preferably a server blade in a data center 210A, 210B. Preferably the worker server 200 is running a desktop operating system. Exemplar of such an operating system is a server running a Microsoft Windows desktop operating system such as Windows XP®, Windows Vista®, Windows 7®, Windows 8®, and Windows Server®.

The operating system of the worker server 200 is modified to support streaming of the multimedia content generated by a desktop application running on a desktop operating system. One method and system embodiment by which this streaming is performed and by which the operating system is modified to perform this task is provided in the copending application “SYSTEM METHOD DEVICE FOR STREAMING VIDEO” Ser. No. 13/471,546 filed May 15 which is incorporated by reference.

The worker server 200, selected by the management server 300, is provide information of the application to execute, a client identifier identifying network address to which the worker server is to connect, and a client identifier to retrieve application-persistent data 410 associated with the client device 100 from the database 400 and the application 205. For Microsoft Windows desktop operating systems, the application-persistent data includes Windows registry variables, environment variables, and data files. By loading the application-persistent data 410, the client device user can resume the use of the application 205 from the point when it was last used. For example, a game application would resume at the point in the game where the game was last played.

The management server 300 selects the worker server 200 to execute for the application requested by the client server 100. The management server 300 selects a worker server 200 based on a number of parameters and worker server 200 associated information in a database 400. First, the management server 300 keeps track of which worker servers are running applications for other clients. The worker server 200 tracking can include but is not limited to the use of a database 400, a flat file, data file, or a combination thereof. A list of free servers are generated for server selection or as a list for selection based on other server selection parameters.

When the management server 300 has identified a set of free servers, it can further make a server selection decision based on the transmission latency between the client device 100 and the worker servers 200. The worker servers 200 can be located in different data centers 210A, 210B which can be located on different sides of the country. These geographical differences between the worker servers and the client devices 100 result in greater transmission latency. Lower transmission latency is important for real-time applications. Thus, if a closer worker server 200 is selected, then the lower the delay in interacting with the worker server 200 executing application and better real-time performance. Preferably the management server 300 will select a worker server 200 that is the closest to the client device 100.

One method of determining the latency is to send a time tagged message between the client device 100 and the worker server 200 and have the worker server echo the message back. Ping is one commonly found operating system function that time tags a message. Ping operates by sending an Internet Control Message Protocol (ICMP) echo request packet and measures the round trip reply time.

Alternatively, geographic location information of the client device 100 can either be provided when the client 100 requests the management server to run an application or can be stored in the database 400. The management server 300 can generate a list of client worker serve distances for all the worker servers or from a list of work servers limited by other server selection parameters.

Another parameter that the management server 300 can use in selecting a worker server 200 is the computational resources of the worker server 200 and a minimum-computational resource of the client requested application. All applications do not require the same computational power to properly execute. Some game applications can require more graphics processing where other less graphically intensive applications can need less computational power. Thus, to save cost and power utilization not all of the worker servers 200 need to be configured with maximum computational resources. Different worker servers 200 can have different computational processing capabilities. The management server 300 can then use as selection criteria a server with at least the minimum computational resources required by the client requested application 205. Further, the selected worker server 200 can be the server with the closest computational resources as required by the application 205. These computational resources can include the CPU (central processing unit) speed, number of CPU cores, CPU ram, and graphic card characteristics including but not limited to the number of graphics processors, and graphic processor memory. The worker server selection can be made by generating a list of all servers meeting the minimum application computational requirement or from a worker server list limited by other server selection parameters.

Another worker server 200 selection criteria can be the applications available for the worker server 200 to execute. Due to licensing restrictions, each data center 210 may only have a limited number of licenses to execute for each application. Thus, if all the licenses are in use at one data center 210A, then the management server 300 will have to choose a different data center 210B with available applications for executing the application. The worker server 200 selection can be made by generating a list of all servers having the applications available for execution or from a worker server list limited by other server selection parameters.

The management server 300 can be separate server, a blade in a data center 210A, 2108, or run as a process on one of the worker servers 200. The management server 300 has a known network address so that the client 100 can connect and make request to run an application 205.

The database 400 is shown as a separate component of the system 1000. The database can be a database server 400 or can be an application running on the management server 300. The database 400 is in communication with both the management server 200 and with each worker server 200.

The database 400 stores information relating to the client device 100, the application 205, and each worker server 200. For each worker server 200, the database can store information of whether the worker server 200 is in use and by which client 100 and for which application 205. The database can store information about the computational resources of each worker server 200. This can include the CPU (central processing unit) speed, number of CPU cores, CPU ram, and graphic card characteristics such and number of graphics processors, and graphic processor memory.

The network 500 is comprised of packet network, cellular and telephone networks, and access equipment including but not limited to wireless routers and hubs. The packet network includes but is not limited to public networks such as the Internet but can include other public and private networks. Preferably the packet network is the Internet running standard protocols including but not limited to TCP, UDP, and IP. However, the cellular network which can couple with the packet network that can include cellular 3G and 4G networks, satellite networks, cable networks, associated optical fiber networks and protocols, or any combination of these networks and protocols required to transport the multimedia-data from the worker server 200 to the client device 100.

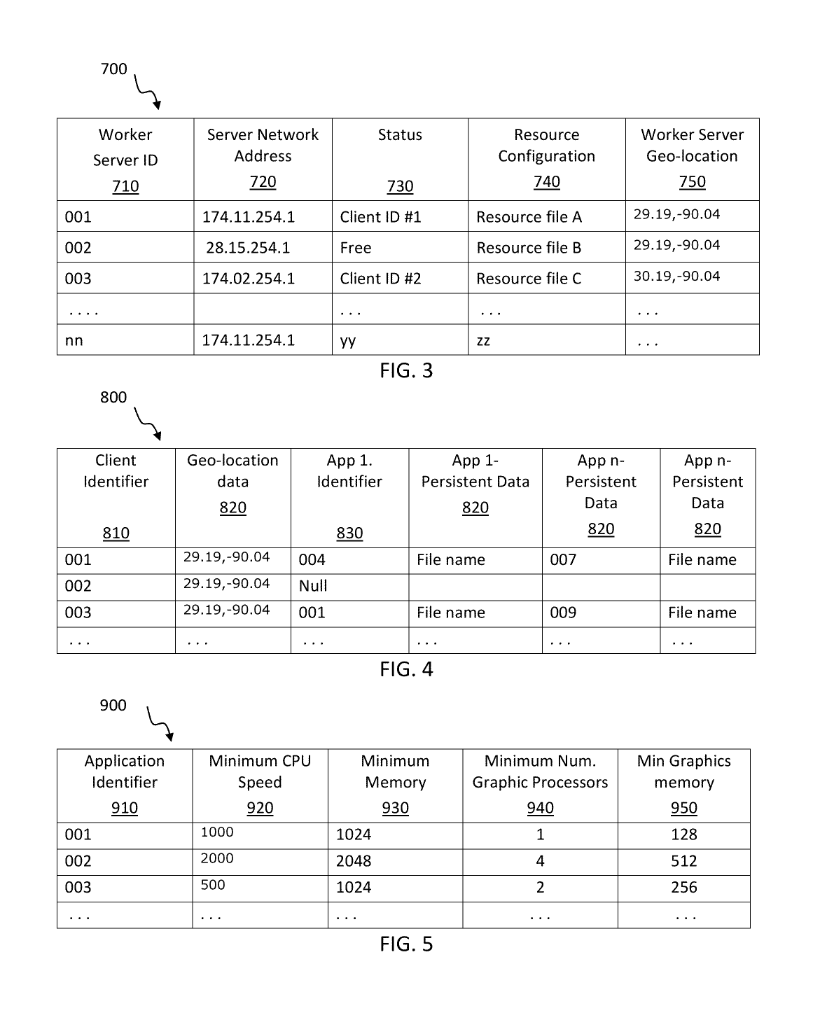

Referring to FIG. 3, a data structure 700 shows one embodiment of data associated with each worker server. The data structure can be stored in a database or in a file. Each worker server ID 710 is unique. Associated with each worker server ID 710 is a server network address 720, a status 720, a resource configuration 740, and an optional worker server geo-location 750 information.

The server network address 720 provides a network address to connect with the worker server. Preferably, the address is an IP (Internet Protocol) address and can be an IP address that is managed dynamically. The status 730 indicates whether a worker server is free for allocation. When being used to run an application for a client, a client identifier of that client is stored in the database and associated with the worker server ID 710. Also associated with the worker server ID 710 is a resource configuration 740. The resource configuration 740 can be a file name or data of the server computational resources. The file name would contain a description of the associated worker server ID 710 computational resources. Optionally, the data structure can include Worker Server Geo-Location data 750. This data can include is preferably in stored in GPS coordinates other coordinated systems are contemplated including longitude and latitude.

Referring to FIG. 4, a data structure 800 shows one embodiment of data associated with each client device. The data structure can be stored in a database or in a file. Each client identifier 810 is unique. Associated with each client identifier 810 is an optional geo-location data 820, No. 1 application identifier 830, and application persistent data 820 associated with No. 1, No. 2 application identifier 830, and application persistent data 840 associated with the No. 2 application identifier 830. More application identifiers and application persistent data can be associated with the client identifier.

Referring to FIG. 5, a data structure 900 shows one embodiment of data associated with each application identifier 910. The data structure can be stored in a database or in a file. Each application identifier 910 is unique. Associated with each application identifier 910 are minimum computational resources needed for the application to execute properly. The computational resources can included but is not limited to minimum CPU processor speed 920, minimum CPU RAM 930, minimum number graphics processors 940, and minimum graphics memory 950.

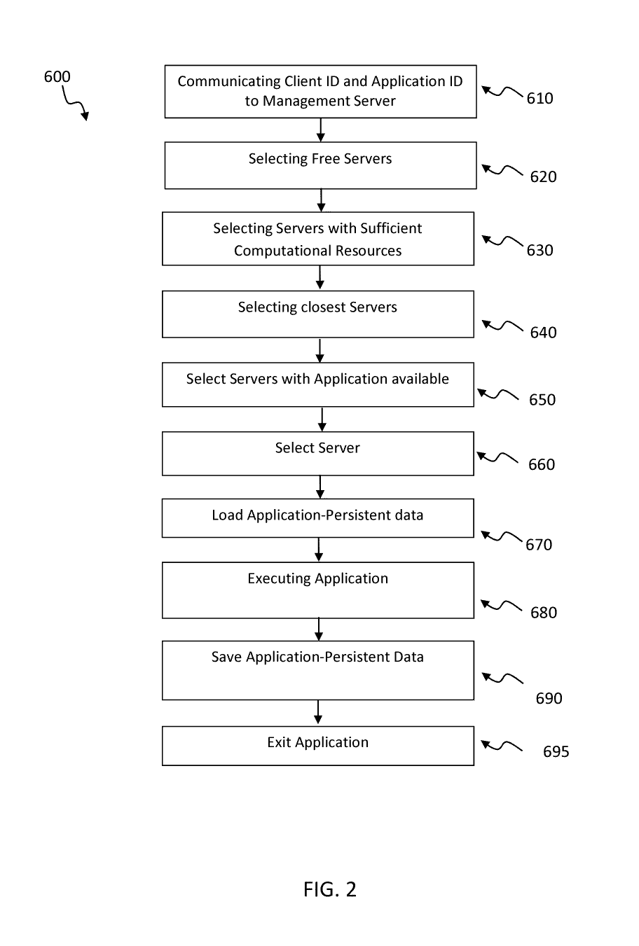

Referring to FIG. 2, another inventive embodiment is shown. A process diagram 600 of selecting a worker server to execute a desk top application and stream the multimedia output of the application to a client device is shown and described. Some of the steps described are optional.

In a step 610, the process begins. A client device communicates a client identifier, and an application identifier to a management server. The client identifier uniquely identifies the client device. The application identifier uniquely identifies a requested application to be executed by the worker server.

Optionally, geo-location tag is sent by the client device. This geo-location information can be user programmed into the client, obtained by a client device associated electronics including but not limited to global positioning electronics or wireless communication triangulation. The communications between the client and the management server can be through a global, public, or private network.

In a step 620, a list of worker servers not being used by other clients is determined by a management server. The tracking of which worker servers are in use can include a database but other methods are contemplated including an internal program data structure and storing the information in a flat file.

In a step 630, the management server determines a list of worker servers that meet the selection parameter of having computational resources greater or equal to the application minimal computational resource requirement. This list can be generated from all of the worker servers or from a list where the worker servers meet other server selection parameters.

Each worker server can have different computational resources. Each client requested application can have a different minimum computational resource needed for executions. The computational resources can include CPU speed, number of CPU cores, CPU RAM, number of graphic processors and graphic processing memory.

In an optional step 640, the selection of the worker server includes creating a list of representative transmission latency between each worker server and the client device. A database or other data structure can be used to store latency location data. This data structure can include geo-location data of the client device and worker server to estimate the transmission latency. The location of the client can be provided by the client or have can be preconfigured in a database. A list of servers and associated client device server distances is determined for each worker server or from a list of worker servers meeting other server selection parameters.

In an optional step 650, a list of worker servers that have the client requested application available to execute is generated by the management server. A database or other data structure can store and tract which worker servers have the client requested application available to run. The list can be generated based on all of the worker servers, or a list limited by one or more worker server selection parameters.

In a step 660, a worker server is selected. The selection of the worker sever is based on the list of available worker servers, the list of worker servers having the minimum computational resources, a worker server having the minimum distance selected from the list of worker server client distances, the list of servers having the client requested application available, or a combination thereof.

In a step 670, application-persistent data associated with the client and the application is loaded into the selected worker server operating system. When an application is stopped and restarted, it may restart on a different worker server. For the application to be able to resume at the same point and configuration, the application-persistent data needs to be available. For Microsoft Windows desktop application, the application-persistent data can include Windows registry variable, environment variables, state files, data files, or a combination thereof. The management server keeps in the database an association between the client identifier, an application identifier and the application-persistent data. Upon the management server selecting a worker server, the application-persistent data is loaded into the worker server operating system and environment.

In a step 680, the application is executed on the selected worker server. The operating system is configured to stream the multi-media content generated by the application to the client device.

In a step 690, the current application-persistent data is saved. Preferably the data is saved in the database with an association with the client device and the application identifier.

In the optional step 695 the application exits.

### Operational Example

In one embodiment of the invention, the system operates as described below. In operation, first a connection between a client device and a worker server is set up. The connection is setup by the client device connecting to a known URL (uniform resource locator) management server over a network that can include the Internet. The URL management server provides the Internet facing URL to which all clients first connect. The management server receives a client identifier, an application identifier and optionally a client geo-location tag used to determine which worker server is the closest and thus presumable has the shortest transmission delay.

The client device can provide login information. The management server will either uses a local database or a network coupled database of client information to determine the applications to which the client has access.

A menu of available applications is sent to the client device for user selection. A client agent, a thread or process, on the management server manages the menu. Upon user selection, the client device sends the management server the client identifier, application identifier, and optional geo-location data.

The management server then selects a worker server to execute the application. First the management server determines the worker servers that are not in use. Next and optionally, the management server determines which of the available servers have the minimal computational resources require for the application. For example, the application may require a 1.5 Ghz CPU, 2 Gigs of CPU memory, and a graphic processor with 256 Megs of memory. The available worker servers that meet this computational processing resource requirement are identified for selection.

Next the management server determines which worker server is the closest to the client device. Either a ping or other type of message is sent to the client device by each available worker server. The message has a time tag and an expected response where the response latency can be determined. Alternatively, the distance between the client device and each worker server can be a proxy to a measured transmission. A geo-location for each worker server is read from a file or a database. The client device's geo-location is either provided by the client or has previously been stored in a data base. A distance between each worker server or the worker servers meeting the availability and computational resource requirements are determined.

Next, the set of worker server that meet the above parameters are then checked for having the application requested by the client available to run. This step can be performed before or after the previous worker server selection steps.

Next the client selected application is executed on the select worker server. When the user chooses to exit the application or it is ended because of inactivity, the worker server stores the current application-persistent data in the database with an association with the client identifier and the application identifier.

What is claimed is:

1. A system for client devices to access server based applications comprising;
a plurality of worker servers each running a desktop operating system and in communication with a global network, wherein each of the worker servers is either in use or not in use;
a management server configured to select a worker server from the plurality of worker servers and configured to communicate with the worker server through the global network;
a client device configured to communicate an application identifier and client identifier to the management server and configured to communicated with the worker server through the global network;
a database configured to communicate with the management server and the plurality of worker servers and configured to store application-persistent data;
wherein the worker server is configured to save in the database application-persistent data associated with the client identifier when the application is ended, wherein the worker server is configured to load the application-persistent data associated with the client identifier into the worker server before starting the application, and wherein the management server is configured to maintain a list indicating a status of available or not available for each of the plurality of worker servers, and wherein the management server is configured to select the worker server that has a status of available.

2. The system of claim 1 wherein the application is a desktop application and the operating system is configured to stream the application generated graphics and audio to the client device.

3. The system of claim 2 wherein the desktop operating system is a Microsoft Windows desktop operating system, wherein the application persistent data is Windows registry variables, environment variables, files, or a combination thereof, wherein the registry variables are loaded into the Windows registry of the worker servers, and wherein the application is a Microsoft windows desktop application.

4. The system of claim 3 wherein the desktop operating system is selected from the group consisting of Microsoft XP, Microsoft Vista, Microsoft 7, Microsoft 8, and Microsoft server.

5. The system of claim 3 wherein the client is configured to communicate a geolocation tag to the management server, wherein the database includes geo-location database of each of the plurality of worker servers, and wherein the management server is configured to calculate a distance between each of the plurality of worker servers with a status of available and the client device, and wherein the selected worker server selected has the smallest distance.

6. The system of claim 3 wherein the worker servers are configure to determine a transmission latency between each the plurality of worker servers with a status of available and the client device, wherein the worker server selected has the shortest transmission latency.

7. The system of claim 5 wherein the database is further configured to include a computational resource for each of the one or more worker servers and wherein the database is configured with an application minimum computational resource associated with each application identified available to each of the plurality of worker servers, and wherein the manager server is configured to select the work server that has at least the application minimum computational resource associated with the application.

8. The system of claim 6 wherein the one or more worker server computational resources includes CPU clock rate, CPU memory, number of graphics processors, graphics processor memory, or a combination thereof.

9. The system of claim 6, wherein the database is further configured to include a list of application identifiers available to each of the plurality of worker servers, wherein the manager server is further configured to select the worker server that has an application available associated with the application identifier.

10. A method of client device accessing server based applications comprising the steps;
communicating from the client device to a management server an application identifier and a client identifier to the management server over a global network;
determining a set of available worker servers from a plurality of worker servers by the management server;
selecting a worker server from the set of available worker servers;
loading a desktop operating system on one the worker server;
loading the worker server with application-persistent data associated with the client identifier and associated with the application identifier from a database;
executing the application on the worker server; and
storing in the database current application-persistent data associated with the client identifier and associated with the application when the application ends.

11. The method of claim 9 wherein the step of determining a set of available worker servers comprise the step of tracking the status of each of the plurality of worker servers, wherein the status indicates whether each of the plurality of worker servers are in-use or not in-use, and wherein the worker server is selected has a status of not in-use.

12. The method of claim 10 wherein the loading the desktop operating system is Windows desktop operating system and wherein the loading application persistent data are Windows registry variables associated with the client identifier and wherein the storing the current application persistent data associated with the client identifier are the application associated Windows registry variables, application files, or a combination thereof.

13. The method of claim 10 further comprising the steps of;
obtaining client device geo-location information from the client device;
retrieving from the database, worker server geo-location information for the set of worker servers;
calculating a list separation distance for each of the set of worker servers with a status of not in-use and the client device geo-location information, wherein the selection of the worker server has a minimum separation distance.

14. The method of claim 10 further comprising the step of determining the transmission latency between the client device and each of the set of worker servers, wherein the selection chooses the worker server that has a minimum latency.

15. The method of claim 13 wherein the determining the transmission latency is done by an Internet Control Message Protocol ping message.

16. The method of claim 13 wherein the determining the transmission latency between each worker server in the set is determined by the time delay of sending a message from each of the set of worker servers to the client device and the client device sending a response message back to the server.

17. The method of claim 10 further comprising the steps of;
retrieving from the database one or more worker computational resources associated with each worker server in the set;
retrieving from the database one or more application minimum computational resources associated with the application identifier;
wherein the selecting the worker server from the set includes selecting the worker server each of the one or more associated worker computational resources are greater than or equal to each of the one or more application minimum computational resource.

18. The method of claim 16 wherein the one or more worker server computational resources associated with each of the plurality of worker servers includes CPU clock rate, CPU memory, number of graphics processors, and graphics processor memory, or a combination thereof.

19. The method of claim 14, including the steps of retrieving from a database a list of available applications associated with each of the plurality of worker servers; and
wherein the step of selecting the set from the plurality of worker server includes selecting worker servers that have available the application associated with the application identifier.
